(19) United States
(12) Patent Application Publication
(10) Pub. No.: US 2024/0371246 A1
(43) Pub. Date: Nov. 7, 2024

(54) AUTHENTICATING OWNERSHIP AND TRANSFER OF ASSETS USING TOKENS

(71) Applicants: Iman Haji Abolhassani, Mountain View, CA (US); Alvin Derek Henrick, Dublin, CA (US)

(72) Inventors: Iman Haji Abolhassani, Mountain View, CA (US); Alvin Derek Henrick, Dublin, CA (US)

(21) Appl. No.: 18/646,082

(22) Filed: Apr. 25, 2024

Related U.S. Application Data
(60) Provisional application No. 63/463,206, filed on May 1, 2023.

(51) Int. Cl. G08B 13/24; H04L 9/32

(52) U.S. Cl. CPC G08B 13/2462; H04L 9/3213

(57) ABSTRACT

A system includes an asset tracking vehicle attached to an asset. A digital token is stored by the asset tracking vehicle, wherein the digital token includes an identifier of the asset. One or more databases store a record of the asset, a record of one or more entities associated with the asset, and past transactions associated with the asset. A computing device includes a software application. The software application is configured to: read or communicate with the asset tracking vehicle; determine the identifier of the asset stored by the digital token; retrieve, through a network connection, from the one or more databases storing the record of the asset, one or more currently authorized entities associated with the asset; and determine, whether a current holder of the asset is one of the one or more currently authorized entities associated with the asset.

### CROSS-REFERENCE TO RELATED APPLICATIONS

This application claims benefit under 35 U.S.C. § 119 (e) of U.S. Provisional Application No. 63/463,206 filed May 1, 2023, which is hereby incorporated by reference herein in its entirety.

### BACKGROUND

Counterfeiting and the illegal transfer of ownership are significant challenges that affect a wide range of assets, both tangible and intangible. Counterfeit products, including digital assets, not only undermine the value of genuine items but also pose risks to consumer safety and the reputations of brands and creators. The rise of counterfeiting and theft, particularly in the realm of luxury and digital goods, has prompted increased efforts to combat these issues. The impacts of counterfeiting are multifaceted, leading to lost sales, damaged reputations, increased operational costs, and diminished profits for legitimate businesses. Similarly, the theft of high-value items, now extending into the digital domain, has escalated, driven by the burgeoning value of these assets and the sophistication of criminal methods.

Digital assets, such as cryptocurrencies, digital art, and online credentials, introduce additional complexities in counterfeiting and ownership management. The inherent characteristics of digital assets, including ease of replication and challenges in verifying authenticity and rightful ownership, demand advanced solutions. The anonymity and decentralized nature of many digital platforms further complicate the enforcement of ownership rights and the identification of counterfeit goods.

### SUMMARY

In one embodiment of the subject technology, a system of authentication of assets is disclosed. The system includes an asset tracking vehicle attached to an asset. A digital token is stored by the asset tracking vehicle, wherein the digital token includes an identifier of the asset. One or more databases store a record of the asset and a record of one or more entities associated with the asset. A computing device includes a software application. The software application is configured to: read or communicate with the asset tracking vehicle; determine the identifier of the asset stored by the digital token; retrieve, through a network connection, from the one or more databases storing the record of the asset, one or more currently authorized entities associated with the asset; and determine, via an immutable ledger, whether a current holder of the asset is one of the one or more currently authorized entities associated with the asset.

In another embodiment, a method of authenticating ownership of an asset is disclosed. The method includes reading, by a computing device, a digital token attached to the asset. Identifier information and holder information of the asset are determined from the digital token. A record of ownership of the asset is retrieved from a database, using an immutable ledger. The software application verifies whether a holder of the asset, is an authenticated, current owner of the asset.

In another embodiment, a computer program product for authenticating ownership of an asset is disclosed. The computer program product includes one or more computer readable storage media, and program instructions collectively stored on the one or more computer readable storage media. The program instructions include reading, by a computing device, a digital token attached to the asset. Identifier information and holder information of the asset are determined from the digital token. A record of ownership of the asset is retrieved from a database, using an immutable ledger. The software application verifies whether a holder of the asset, is an authenticated, current owner of the asset.

The techniques described herein may be implemented in a number of ways. Example implementations are provided below with reference to the following figures.

### BRIEF DESCRIPTION OF THE FIGURES

The detailed description of some embodiments of the invention is made below with reference to the accompanying figures, wherein like numerals represent corresponding parts of the figures.

FIG. 1 is a block diagram of a system for authenticating an asset according to an embodiment of the subject technology.

FIG. 2 is a flowchart of a method for registering an asset in an authentication system according to an embodiment of the subject technology.

FIG. 3 is a flowchart of a method for authenticating an asset according to an embodiment of the subject technology.

### DETAILED DESCRIPTION OF CERTAIN EMBODIMENTS

### Overview

In general, and referring to the Figures, embodiments of the disclosed subject technology provide authentication of consumer goods. The present disclosure introduces a high-security, technology-backed governance system for the authentication and transfer of ownership of assets. This system is designed to enforce the authorized use of an asset by its legitimate owners, addressing the critical challenges posed by counterfeiting and unauthorized ownership transfers. By ensuring the integrity and authenticity of both tangible and intangible assets, this technology offers a robust solution to protect the interests of owners and creators in the digital age.

The term “asset” in this context encompasses a broad spectrum of tangible and intangible items of value. Tangible assets include physical goods, such as consumer products and luxury items, while intangible assets cover digital goods, intellectual property, and other non-physical entities. This comprehensive definition underlines the diverse nature of assets that the current disclosure aims to protect.

Embodiments may use digital tokens including non-fungible tokens (NFTs) to tag, track, and authenticate an asset. Consumer goods that are subject to authentication include, for example, luxury items. A luxury item may be an expensive good or service that is not essential for survival or comfort. Luxury items are often associated with high social status and prestige. They can be used to express one's wealth, taste, and personality. Luxury items are often made from high-quality materials and are designed to be stylish and fashionable. They may also have unique features or benefits that make them more desirable than other, less expensive items. Luxury items can be a status symbol; owning them can make people feel good about themselves. They can also be a way to show off one's wealth and success.

### Example System Architecture and Methodology

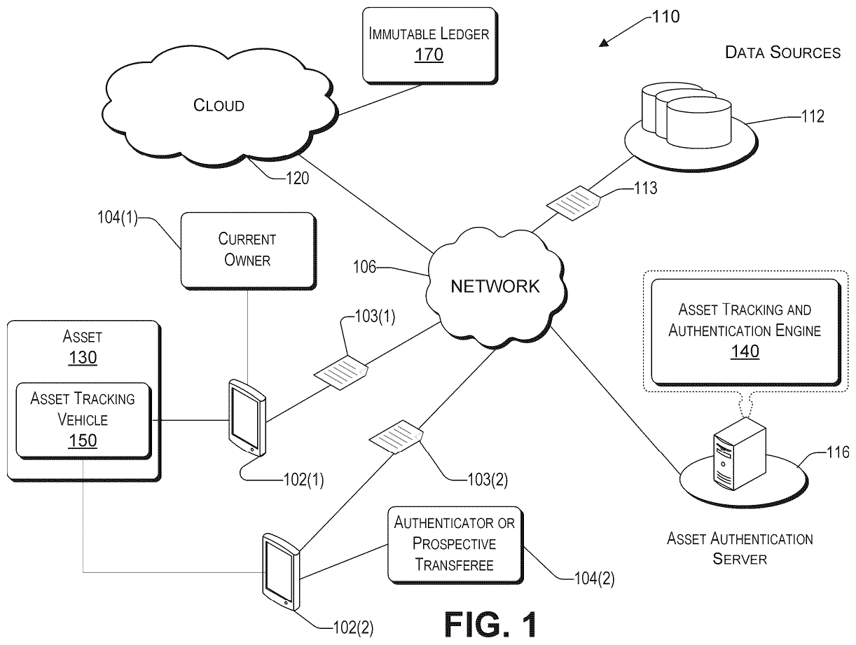

FIG. 1 shows a system architecture 110 for authenticating a consumer good (or other item such as a service) according to an embodiment. The system architecture 110 includes a network 106 that allows various computing devices (for example, 102(1) and 102(2)) to communicate with each other, as well as other elements that are connected to the network 106, such as data source 112, an asset authentication server 116, the cloud 120, and an immutable ledger 170, for example, a blockchain network. Assets, entities, and transactions may be stored in the immutable ledger. In some embodiments, a “transactions” database keeps track of ownership, chain of title or custody, lineages etc. This may be stored on using blockchain or some other form of a ledger. The asset authentication server 116 may operate software that authenticates the ownership or authorization of an asset through for example, the asset tracking and authentication engine 140.

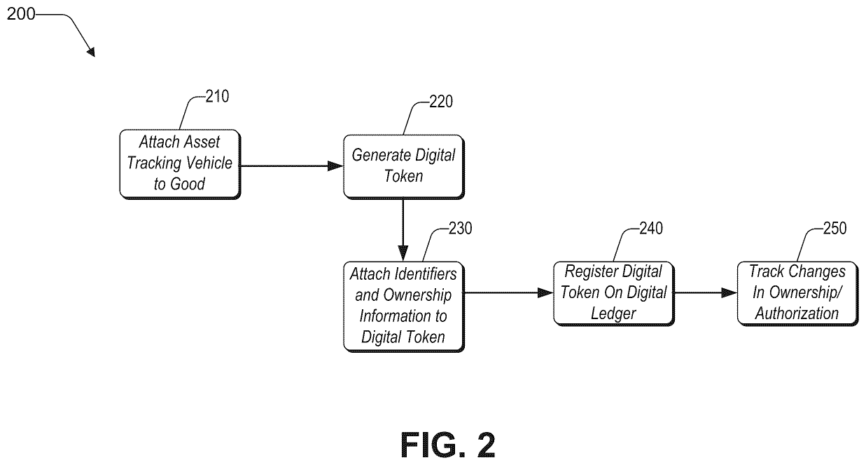

Embodiments may include an asset tracking vehicle 150, which will generally reside directly on an asset 130 that is monitored for authenticated ownership. Referring now concurrently to FIG. 2, which shows a method 200 for registering an asset for authentication according to an embodiment, the current owner 104(1) may attach 210 an asset tracking vehicle 150 to an asset 130. The asset tracking vehicle 150 may be either a physical device, a digital element or a combination of both physical and digital elements. For example, in some embodiments, the asset tracking vehicle 150 may include a physical token. The asset tracking and authentication engine 140 (or sometimes a downloaded program resident on computing device 102(1)), may generate 220 a digital token associated with the asset 130. The digital token may be associated with the physical token. Details of embodiments of the digital token are described further below. Identifiers of the asset 130 and ownership information may be attached 230 to the digital token and sent via one or more data files 103(1) into the network 106 to the asset authentication server 116 where the asset tracking and authentication engine 140 saves a record 113 of the newly minted digital token and ownership information in data sources 112. In some embodiments, the record 113 may be registered 240 in the immutable ledger 170 (accessed through the cloud 120). Changes in ownership or authorization may be tracked 250. The following is an example of a change in ownership or authorization to access/transfer the asset 130 that may be administered using the system architecture 110.

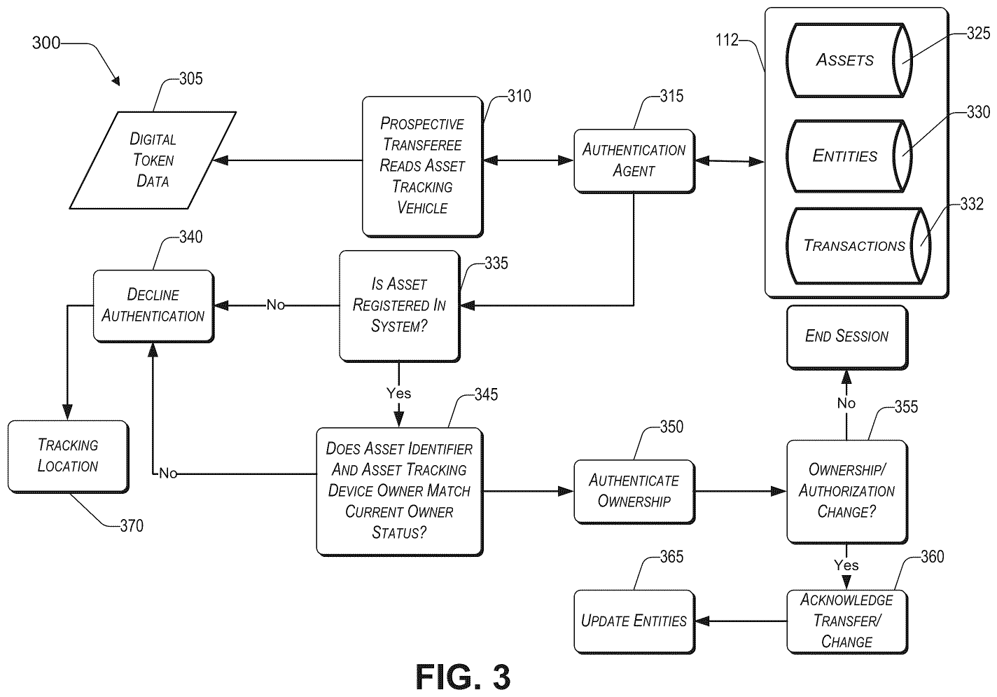

Reference is now made to FIG. 3, which shows a method 300 of authenticating ownership and tracking changes in ownership status, concurrently with FIG. 1. Generally, when a prospective transferee 104(2) (or other entity) engages a current owner (or authorized entity) 104(1) to determine the authenticity of ownership in the asset 130, the authenticator or the prospective transferee 104(2) reads 310 the asset tracking vehicle for the digital token data 305. An authentication agent may transmit 315 a request 103(1) for an authenticating record of the asset 130. The request 103(1) may be sent to the asset authentication server 116 where the asset tracking and authentication engine 140 may check the data sources 112 for current ownership or authorization entities.

In some embodiments, the data sources 112 may include a database 325 of assets registered in the system, a database 330 of entities associated with each asset, and a database 332 of transactions. The database 330 of entities associated with each asset may contain a chain of title/authorization that shows all previous owners/authorized entities (as well as current owners/authorized users) for each asset 130 that is registered. The database 332 of transactions may store all past transactions associated with each asset 130. When changes to ownership or authorization occur, the transactions database 332 may be used to authenticate 340 and register the transaction. When a request for authentication is made, the immutable ledger 170 may be used to verify the authenticity of the current ownership/authorization status of the asset 130.

The asset tracking and authentication engine 140 may preliminarily determine 335 whether the asset 130 is registered in the data sources 112. For assets that are not registered, their authenticity cannot be verified and thus the authentication may be declined 340. As may be appreciated, this feature protects against counterfeit goods that purport to have a valid authentication element. For registered assets 130, the asset tracking and authentication engine 140 may determine 345 whether the asset being checked has an asset identifier and is using an asset tracking device whose current holder matches the current ownership status in the entities database 330. The “asset tracking device” in some embodiments is not always the same computing device 102(1), but can also be an account in a software application installed on the computing device 102(1) (for example, in the event the owner has more than one, or upgrades/switches the computing device 102(1)). When the identifier for the asset 130 or asset tracking device do not match the current ownership/authorization records, authentication may be declined 340. Otherwise, ownership/authorization of the asset 130 may be authenticated 350 by the asset tracking and authentication engine 140.

In some embodiments, the asset tracking and authentication engine 140 may receive 355 a change in ownership/authorization message. After acknowledging 360 the change in ownership/authorization status, the asset tracking and authentication engine 140 may update 365 the chain of title in the entities database 330. The transactions database 332 may be used to register the transaction and change in ownership, thus preserving the authenticity of ownership in the asset 130. In some embodiments, should the asset tracking and authentication engine 140 decline authentication (on whatever basis), the asset tracking and authentication engine 140 may issue a status blocking the future transfer of the asset 130. In some embodiments, the asset tracking and authentication engine 140 may track 370 a current location of the asset (sometimes by tracking an origin of a message requesting authentication) so that the location can be provided to the owner or third parties to repossess the asset 130.

Referring back solely to FIG. 1 now for additional details on some aspects of the system architecture 210, the network 206 may be, without limitation, a local area network (“LAN”), a virtual private network (“VPN”), a cellular network, the Internet, or a combination thereof. For example, the network 106 may include a mobile network that is communicatively coupled to a private network, sometimes referred to as an intranet that provides various ancillary services, such as communication with various application stores, libraries, and the Internet. The network 106 allows the asset tracking and authentication engine 140, which is a software program running on authentication server 116, to communicate with the data sources 112, computing devices 102(1) and 102(2), and/or the cloud 120, to provide data processing. In some embodiments, the data sources 112, the asset authentication server 116, and the immutable ledger may all, or some combination thereof, be stored and accessed through the cloud 120.

While the data sources 112 and the asset tracking and authentication engine 140 are illustrated by way of example to be on different platforms, it will be understood that in various embodiments, the data sources 112 and the authentication server 116 may be combined. In other embodiments, these computing platforms may be implemented by virtual computing devices in the form of virtual machines or software containers that are hosted in the cloud 120, thereby providing an elastic architecture for processing and storage.

Some embodiments of the system include features for enhanced access control and restrictions. The access control and restriction settings may be provided within an asset management application. The asset management application may include an authentication control designating authorized user groups. The asset management application may include usage limitation functions that limit temporal access and/or usage count access to parties. The asset management application may have a setting that restricts transfers to or from a party. The restriction settings regulate asset distribution and ownership of assets as further safeguards to prevent unauthorized transfer or access to an asset. The asset management application may include authentication location blocking which only allows authentication within a specific geographic region by the owner. The location-based authentication restriction may prevent transfers from occurring in places far from the true ownership location of an asset in the event an asset is moved far away from the owner and where security measures can be overcome by circumventing local cyber security rules.

### Definitions and Example Details

### Ownership

An “owner” entity in this disclosure refers to one or multiple persons or a business entity. Multiple entities may own an asset, so in some embodiments, all entities' tokens may be linked to the asset's digital token in the entities database 330 as owners. A “user” entity in this disclosure may refer to one or multiple persons or business entities. Multiple entities may use or have access to an asset 130 so all entities' tokens may be linked to the digital token in the entities database 330 as users (i.e., authorized users). An “authenticator” entity may be the owner, the authorized user, or an entity authorized by the owner or the user to authenticate the asset 130. Each authentication session, along with the authenticator's token may be stored in the data sources 112. An example of an “authenticator” is a future prospective owner or user who wants to authenticate the asset before purchase or usage.

During an authentication session, the authenticator's token along with other information, including, the asset tracking device location, authentication time, etc., may be collected and stored in the data sources 112 for fraud/theft detection, usage analysis, or reporting.

### Digital Token

The digital token may be any unique token for identifying an asset. In some embodiments, the digital token may be a non-fungible token (NFT) which is a unique digital asset that another asset cannot replace. NFTs are created using blockchain technology, which is a secure and tamper-proof way to store data.

### Physical Token

In some embodiments the asset tracking vehicle may include a physical device that stores the digital token data. The physical token may be physically attached to the asset. The asset tracking device may be configured to read the digital token data in/on the physical token.

### Identifiers

In some embodiments, identifiers of the asset 130 may include a manufacturer's unique serial number or another entity's identifying number. In some embodiments, the identifier number may be static or may be a dynamic code (in which case the assets database 325 may need to be updated after each code update). Other identifying information may include the owner's token, the users' token, the authenticators' token, manufacturer, model number, serial number, photos of the asset, asset specifications, date of manufacture, and data of past purchases.

### Asset Tracking Vehicle

Embodiments of asset tracking vehicles include for example, Near-Field Communication (NFC) chips, RFID chips, QR codes, and barcodes. The asset tracking vehicle (ATV) may be installed in or on the asset that is subject to authentication or may accompany the asset as a separate item. Having an ATV may simplify and facilitate the process of reading the digital token and transmitting it to the authentication server 116. The digital token may be stored on other types of memory, including computer electronic memory (e.g., hard disks, flash drives, etc.) or hard copy (printed on paper). In some embodiments, the asset tracking vehicle may also be attached to a certificate that comes with the item (i.e., accompany the item). For example, a chip may be embedded inside the certificate that comes with a luxury watch.

When an authenticator wishes to authenticate the asset, the token on the asset may be scanned using an asset tracking device (ATD) with the ability to read the token from the ATV. One embodiment of an ATD is a smartphone. The ATD retrieves the data from the token(s) for comparison to the data in the databases 325, 330, and 332. In another embodiment, for example, when no ATV is used, the app may be directly provided with the token (for example, through copying and pasting it from the electronic memory or manually inputting it in the app).

In some embodiments, the owner's and/or the user's and/or the authenticator's (if not an owner or user) token may also be required for authentication. In that case, the same ATD or another device (for example, a computer or processing capable device dedicated for authentication under the subject technology) may be used to provide this token.

In some embodiments, an identity validation (IV) mechanism may be used to validate the owner and/or user and/or authenticator entity token at the time of authentication. Embodiments of an IV mechanism include, email verification, one time password/code generation, and biometric verification. Depending on the desired IV security level, none, one, or more IV validation mechanisms may be required for IV.

In some embodiments, the token data and the owner and/or user token (if required) and/or the authenticator token (if required) and the IV (if required) are transferred to the databases 325 and 330. If the data matches the data in the databases 325, 330, and/or 332, then the asset is determined to be authentic.

### Theft Prevention

In the case of a product theft, the owner, or the manufacturer of the device, or an elected entity may have the option to flag the product (asset) as stolen, and hence block future product authentications and transfers. Validating that the asset is indeed stolen may require a report from authorities, including a police report.

The owner of the stolen asset may be provided with a newly generated token. In some embodiments, the owner may receive a newly manufactured asset as replacement for free or discounted, while the stolen asset token will be flagged as stolen in the database.

While authenticating a stolen asset, the app will clearly show its status as stolen, and may collect information on the asset's location, using the location services from the ATD (e.g., the smartphone) of the authenticator, if location information is available. Further ownership transfers of a stolen asset may be blocked until the asset is retrieved from the thieves.

In case of identity theft, the owner's, the user's, or the authenticator's token in the system may be replaced by a newly generated token and the old token may be marked as stolen. This process may require a report from authorities, including a police report for identity theft. The flagged entity token will be blocked from performing future transactions.

The combination of asset token plus owner token and/or user token (if applicable) and/or authenticator token (if applicable), and entity identity validation as an authentication option significantly strengthens the process of asset authentication and makes it tamper proof. Using a portable device like a smartphone to handle this process for reading tokens and/or running the authentication app significantly facilitates the process of authentication.

The above-described authentication may be defined as a requirement for using the asset if it applies (for example for consumer electronics or industrial machinery) every time the asset is used, or based on a frequent temporal identification schedule, or at random times, or based on other specific usage criteria for that asset to ensure the product is used by the owner and or the authorized user(s) only.

Some embodiments may include a function in the asset management application for the owner to “approve” authentications of their assets. An example of such an approval is accepting a “push notification” on their phone. The owner may choose to reject the authentication attempt if they wish so, or ignore it and let the attempt expire. This feature prevents spoofers from copying the authentication information and attaching a fake token or other identifier to another article and using the fake token (or otherwise) to fool a would-be transferee of buying a fake asset using the fake identifier.

The subject technology provides a number of advantages over prior art methods for authenticating items. First, the method is secure and tamper-proof. The NFT (if chosen as the method for token generation) is stored on a blockchain, which is a secure and tamper-proof way to store data. Second, the method is scalable. The method can be used to authenticate a large number of luxury and non-luxury items. Third, the method is cost-effective. The cost of authenticating a luxury item using the present disclosure is significantly lower than the cost of authenticating a luxury item using traditional methods, such as physical inspection by a certified appraiser. Moreover, the proposed authentication process has the option of owner and user identity validation, which further increases the security of the authentication and ownership transfer processes. Finally, all of the processes can be carried out using a portable device (for example, a smartphone), allowing the authentication and ownership transfer to be done by the public, further expanding the applicability of this technology and reducing the sales of stolen assets.

### Insurance Fraud Prevention

The subject technology may be implemented by an insurance company to insure the product. If the item is lost or stolen and insurance is claimed by the owner, the insurance money is paid to the owner by the insurance company, but the subject technology records a change in ownership so that the intangible or tangible ownership of the lost or stolen item is transferred to the insurance company in exchange. For example, the databases 325, 330, and 332 are updated to show a transfer of ownership in the insured asset to the insurance carrier. Whether the asset covered by insurance is purported to be lost or destroyed, the system will flag the ownership of the asset as being held by the insurance company after payout of a policy. Should the asset holder attempt to sell/transfer the covered asset that was paid out for, the system will show that the owner no longer has a legitimate title to the asset. As may be appreciated, the subject technology has the potential to block significant insurance fraud cases.

### Support for Software Embodiments

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the disclosed invention may take the form of a computer program product embodied in one or more computer readable media having computer readable program code embodied thereon.

Any combination of one or more computer readable media may be utilized. In the context of this disclosure, a computer readable storage medium may be any tangible or non-transitory medium that can contain or store a program for use by or in connection with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing.

Aspects of the disclosed invention are described below with reference to block diagrams of methods, apparatus (systems) and computer program products according to embodiments of the invention. It will be understood that each block of the block diagrams, and combinations of blocks in the flowchart illustrations and/or block diagrams, can be implemented by computer program instructions. These computer program instructions may be provided to the processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

### Caveats

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A system of authentication of assets, comprising:
an asset tracking vehicle attached to an asset;
a digital token stored by the asset tracking vehicle, wherein the digital token includes an identifier of the asset;
one or more databases storing a record of the asset, a record of one or more entities associated with the asset, and a record of one or more past transactions associated with the asset;
a computing device including a software application, wherein the software application is configured to:
read or communicate with the asset tracking vehicle;
determine the identifier of the asset stored by the digital token;
retrieve, through a network connection, from the one or more databases storing the record of the asset, one or more currently authorized entities associated with the asset; and
determine whether a current holder of the asset is one of the one or more currently authorized entities associated with the asset.

2. The system of claim 1, wherein the digital token is a non-fungible token (NFT).

3. The system of claim 1, wherein the software application is further configured to:
acknowledge a transfer in ownership of the asset; and
authenticate the transfer in ownership through the blockchain.

4. The system of claim 3, wherein the software application is further configured to update, via the one or more databases, an ownership status of the asset in response to the transfer of ownership.

5. The system of claim 1, wherein the asset tracking vehicle includes a physical token storing the digital token.

6. The system of claim 5, wherein the physical token is one of: a Near-Field Communication (NFC) chip, a radio frequency identification (RFID) chip, a QR code, or a barcode.

7. A computer implemented method of authenticating ownership of an asset, comprising:
reading, by a computing device, a digital token attached to the asset;
determining, by a processor in the computing device, identifier information and holder information of the asset from the digital token;
using an immutable ledger, retrieving from a database, a record of ownership of the asset; and
verifying by the processor whether a holder of the asset, is an authenticated, current owner of the asset.

8. The method of claim 7, further comprising:
acknowledging a transfer in ownership of the asset; and
authenticating the transfer in ownership through the immutable ledger.

9. The method of claim 8, further comprising updating, via the immutable ledger, an ownership status of the asset in response to the transfer of ownership.

10. The method of claim 7, further comprising:
in an event the holder is not verified, declining an authentication of the asset; and
tracking a location of the asset in response to the declination of authentication.

11. The method of claim 7, wherein the digital token is a non-fungible token (NFT).

12. A computer program product for authenticating ownership of an asset, the computer program product comprising:
one or more non-transitory computer readable storage media, and program instructions collectively stored on the one or more computer readable storage media, the program instructions comprising:
reading, by a computing device, a digital token attached to the asset;
determining, by a processor in the computing device, identifier information and holder information of the asset from the digital token;
using an immutable ledger, retrieving from a database, a record of ownership of the asset; and
verifying by the processor, whether a holder of the asset, is an authenticated, current owner of the asset.

13. The computer program product of claim 12, wherein the program instructions further comprise:
acknowledging a transfer in ownership of the asset; and
authenticating the transfer in ownership through the immutable ledger.

14. The computer program product of claim 13, wherein the program instructions further comprise updating, via the blockchain, an ownership status of the asset in response to the transfer of ownership.

15. The computer program product of claim 12, wherein the program instructions further comprise:
in an event the holder is not verified, declining an authentication of the asset; and
tracking a location of the asset in response to the declination of authentication.

16. The computer program product of claim 12, wherein the digital token is a non-fungible token (NFT).
